(19) United States
(12) Patent Application Publication
(10) Pub. No.: US 2003/0127577 A1
(43) Pub. Date: Jul. 10, 2003

(54) Tool hanger

(76) Inventor: James Brown, Durham, NC (US)

Correspondence Address: Dean T. Woodward, 16 St. Andrews Ct., Durham, NC, 27707, US

(21) Appl. No.: 10/039,573

(22) Filed: Jan. 7, 2002

(51) Int. Cl. F16B 45/00; A47H 1/10

(52) U.S. Cl. 248/304; 248/301

(57) ABSTRACT

A stationary hanger for tools that provides a safe way to suspend tools at an elevated position while not inhibiting normal tool functionality. The inventive device is a single L-shaped hanger having vertically and horizontally oriented pieces formed by approximately a 90° bend, the horizontally oriented portion has one or more apertures, whereby the number and/or pattern of the aperture(s) permit secure connection of the hanger to a tool. This new hanger for tools provides safety and convenience measures not heretofore available.

### BACKGROUND OF THE INVENTION

1. Field of Invention

This invention relates to hangers and more particularly to a new hanger apparatus that when properly oriented provides a safe way to suspend tools in a stable configuration.

2. Description of Prior Art

In general, various hooks and hangers have been proposed to hang a variety of objects from planters to power tools. More specifically, previous hooks and hangers were designed to consist of similar structural configurations. However, these adaptations did not provide long-term stability and ease of use. One invention in the prior art is a hook with a single aperture used for air nailers and air staplers. This hook is a temporary hook that does not stay stationary, thus causing possible injury and damages. This hook also slows down productivity because the hook occasionally gets in the way of loading the fasteners into the air nailers and air staplers. Also, this hook is placed between the air fitting and the tool, restricting the number of threads that are used to make an airtight connection. Finally, when this hook becomes loose, the single aperture gets worn and is no longer useful.

The present inventive device is a single L-shaped hanger having vertically and horizontally oriented pieces formed by approximately a 90° bend. In a first embodiment of the present invention, the horizontally oriented portion has two or more apertures, thus enabling secure connection to a tool. In a second embodiment of the present invention, the horizontally oriented portion has one or more non-circular apertures that enable secure connection to a tool.

In one application of the first embodiment described above, a large central aperture is located in the center of the end attached to the tool, with the remaining apertures located radial to the central aperture at specific angles based on exact product specifications therefor. The central aperture is dimensioned to fit between the handle of the tool and its respective end cap, which houses the pneumatic air fitting for connection of the pneumatic air hose. The pneumatic air fitting threads through the end cap of the tool and passes through the existing gasket presently residing underneath the end cap of the tool, resting directly above the central aperture of the hanger, allowing air to flow freely. An additional gasket is placed between the hanger and the handle of the tool. The tool's connector bolts pass through the end cap of the tool, the remaining specifically oriented apertures of the hanger, and the gaskets, thereby providing a complete seal between the pneumatic air fitting and the end cap of the tool and the stationary hanger.

Other applications of the present invention may or may not require gaskets, as would be the case where the tool is not pneumatic, or where the present invention is attached to a pneumatic tool in a location or manner that does not make direct contact with the pneumatic air flow.

Hence, the primary objective of this invention is provide a hanger for tools that provides a safe, efficient, inexpensive, long-term solution for suspension of generic as well as specific tools at elevated heights not heretofore available.

Therefore, the present hanger invention for tools deviates from the presently available concepts and designs, and in so doing provides an apparatus primarily developed for the purpose of providing a safe way to suspend a tool at an elevated position without inhibiting the normal function of the tool.

### SUMMARY OF INVENTION

In view of the foregoing disadvantages inherent in the known types of hangers or hooks now present in the prior art, the present invention provides a new hanger for tools which has as many of the advantages of the hangers or hooks mentioned heretofore and many novel features that result in a new hanger for tools which is not anticipated, rendered obvious, suggested, or even implied by any of the prior art hangers, either alone or in any combination thereof.

To achieve this, a first embodiment of the present invention is comprised of a single L-shaped hanger having vertically and horizontally oriented pieces formed by approximately a 90° bend, wherein the horizontally oriented portion has two or more apertures to enable secure attachment to a tool. In a common representation of this first embodiment, a large central aperture is located inwardly of the free end with the remaining apertures located radial to the central aperture at specific angles based on exact product specifications therefor.

A second embodiment of the present invention is comprised of an L-shaped hanger as described above, wherein the horizontally oriented portion has one or more non-circular apertures for secure attachment to the tool.

In either embodiment, the hanger as described is preferably manufactured with the user needs of durability, strength, and adjustability in mind. Typically, these needs would suggest that the hanger is made from a non-brittle metal or polymer material to allow bending, thereby allowing the hanger to be bent to accommodate the particular tool, method of use and environment. However, the hanger would typically also be required to support the tool in a stable configuration for extended periods, and would therefore be manufactured to a thickness whereby the hanger would not bend while supporting the tool. The selection of materials and thicknesses for the purposes described herein is well understood in the art.

There has thus been outlined, rather broadly, the more important features of the invention in order that the detailed description thereof that follows may be better understood, and in order that the present contributions to the art be better appreciated. There are additional features of the invention that will be described hereinafter and which will form the subject matter of the claims appended hereto.

It is to be understood that the invention is not limited in its application to the details of construction and to the arrangements of the components set forth in the following description or illustrated in the drawings. The present invention is capable of other embodiments, of being practiced, and carried out in various ways. In addition, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent construction insofar as they do not depart from the spirit and scope of the present invention.

Further, the purpose of the forgoing abstract is to enable the U.S. Patent an Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a new hanger for tools that can be connected to any part of a tool. In addition, a new method which has many advantages of the hooks and hangers mentioned heretofore and many novel features that result in a new hanger for tools which is not anticipated, rendered obvious, suggested, or even implied by any of the prior art hangers or hooks, either alone or in any combination thereof.

It is another object of the present invention to provide a new hanger that is connected to a tool for maximum stability and safety.

A further object of the invention is to limit damages that would occur to either the work environment or the tool itself.

It is a further object of this invention to provide a hanger that is stationary, in order to speed productivity.

Still yet another object of this invention is to provide a new hanger for tools that is durable and cost effective.

It is another object of the present invention to provide a new hanger for tools that may be easily and efficiently manufactured and marketed.

Even still another object of the present invention is to provide a hanger for tools that provides in the apparatuses and methods of the prior art some of the advantages thereof, while simultaneously overcoming the disadvantages normally associated therewith.

### BRIEF DESCRIPTION OF THE DRAWINGS

FIG. 1 is a perspective view of one embodiment of the instant invention;

FIG. 2 is a perspective view of one embodiment of the instant invention in combination with a tool;

FIG. 3 is a perspective view of a second embodiment of the instant invention;

FIG. 4 is a perspective view of a second embodiment of the instant invention in combination with a tool

### DETAILED DESCRIPTION OF THE PREFERRED EMBODIMENT

Although the invention is described in terms of a specific embodiment, it will be readily apparent to those skilled in this art that various modifications, rearrangements and substitutions can be made without departing from the spirit of the invention. The scope of the invention is defined by the claims appended hereto.

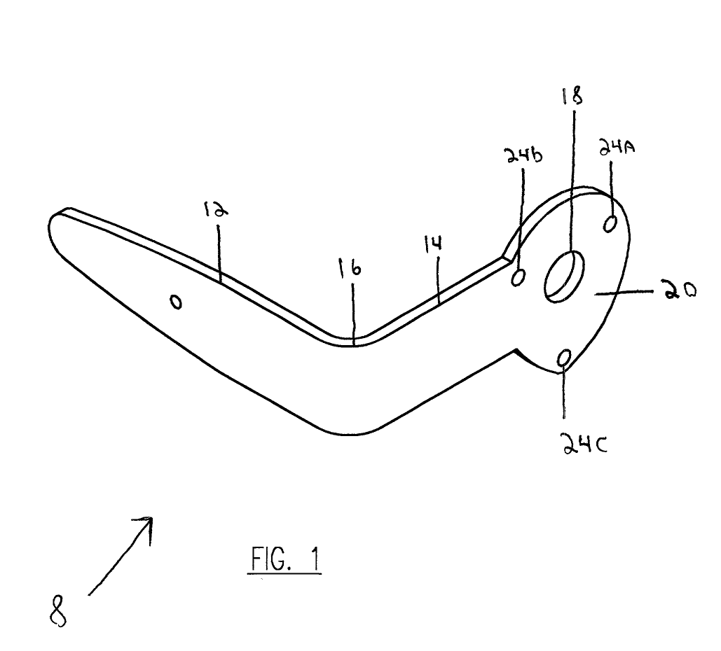

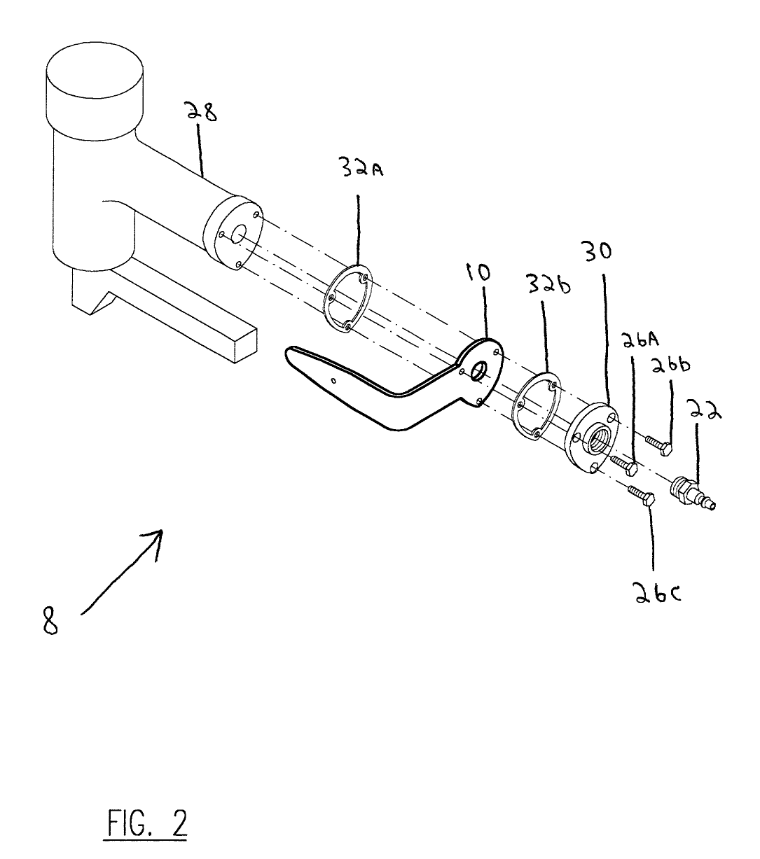

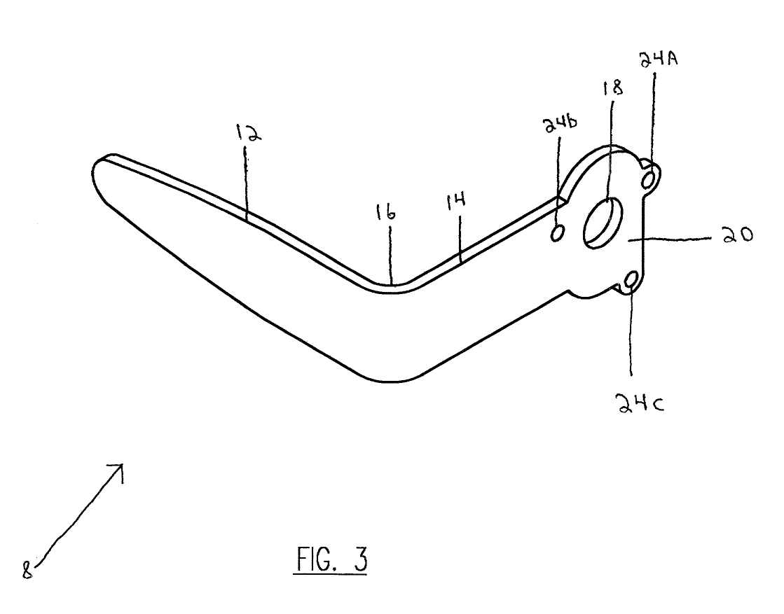

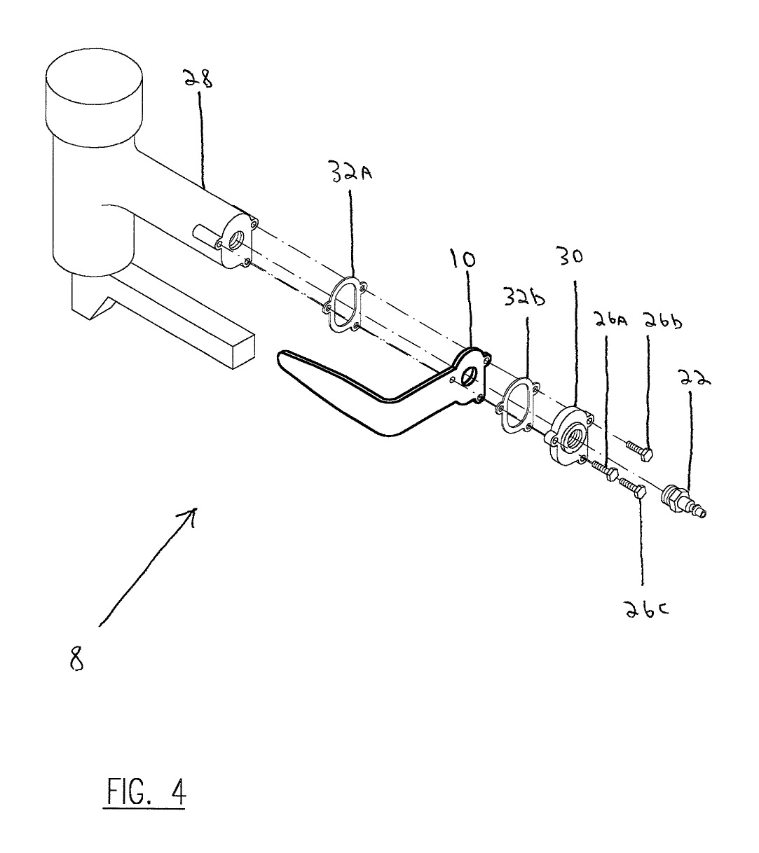

With reference now to the drawings, and in particular to FIGS. 1 through 4 thereof, one embodiment of a new hanger for tools embodying the principles and concepts of the present invention and generally designated by the reference numeral 8 will be described.

As illustrated in FIGS. 1 through 4, the hanger for tools 8 comprises a secure hanger for a tool that would enable the tool to be safely hung on a ladder, a rafter, or even the users belt. The present invention comprises an L-shaped hook portion 10 having a vertically oriented portion 12 and a horizontally oriented portion 14 joined together at a bend 16. The horizontally oriented portion 14 has a central aperture 18 there through disposed inwardly of a specifically shaped portion 20 thereof. The aperture 18 is dimensioned for fitting over a pneumatic air fitting 22. The specifically shaped portion 20 also consists of a multitude of apertures 24a, 24b, and 24c permitting bolts 26a, 26b, and 26c to pass through.

In use, the central aperture 18 permits air passage from the air fitting 22 into the tool 28. The user would remove the bolts 26a, 26b, and 26c from the tool 28. Then the user would remove the end cap 30 from the tool 28. The gasket 32a is typically pre-existing. The user would add the instant invention 10. The user may also add an identical gasket 32b. Then the user would place the end cap 30 over the gasket 32b and use the bolts 26a, 26b, and 26c to make the instant invention 10 completely secure to the tool 28. The multiple of apertures can be arranged in any configuration or multitude to permit a cost effective, durable, safe, and secure connection to the tool 28.

What is claimed is:

1. A tool hanger, comprising:
a horizontally oriented portion;
a vertically oriented portion joined together with said horizontally oriented portion at first ends thereof at a bend; and
two or more apertures located at the second end of said horizontally oriented portion, wherein said apertures are so dimensioned and so spaced so as to permit secure connection to and combination with a hand-held tool in an orientation such that the combination of hanger and tool can be suspended in a desired location in a stable configuration.

2. The tool hanger set forth in claim 1, wherein one aperture is located in the center of said second end of said horizontally oriented portion.

3. A tool hanger as described in claim 1 or 2, wherein any or all of said apertures are threaded.

4. A tool hanger as set forth in claim 1, wherein said hanger can be adjustably bent.

5. A tool hanger as set forth in claim 1, wherein said horizontally oriented portion is longer than said vertically oriented portion.

6. A tool hanger as set forth in claim 1, wherein said horizontally oriented portion is the same size or shorter than the vertically oriented portion.

7. A tool hanger as set forth in claim 1, wherein said second end of said horizontally oriented portion is enlarged relative to the remainder of the horizontally oriented portion.

8. A tool hanger as set forth in claim 1, wherein said second end of said horizontally oriented portion becomes a substitute or replacement for part of the tool's housing.

9. A tool hanger, comprising:
a horizontally oriented portion;
a vertically oriented portion joined together with said horizontally oriented portion at first ends thereof at a bend; and
one or more apertures located at the second end of said horizontally oriented portion, wherein one or more of said apertures are non-circular so as to permit secure connection to and combination with a hand-held tool in an orientation such that the combination of hanger and tool can be suspended in a desired location in a stable configuration.

10. A tool hanger set forth in claim 9, wherein said hanger can be adjustably bent.

11. A tool hanger set forth in claim 9, wherein said horizontally oriented portion is longer than said vertically oriented portion.

12. A tool hanger set forth in claim 9, wherein said horizontally oriented portion is the same size or shorter than the vertically oriented portion.

13. A tool hanger set forth in claim 9, wherein said second end of said horizontally oriented portion is enlarged relative to the remainder of the horizontally oriented portion.

14. A tool hanger set forth in claim 9, wherein said second end of said horizontally oriented portion becomes a substitute or replacement for part of the tool's housing.
